(19) United States
(12) Patent Application Publication
(10) Pub. No.: US 2021/0271253 A1
(43) Pub. Date: Sep. 2, 2021

(54) METHOD AND APPARATUS FOR CONTROLLING DEVICE TO MOVE, STORAGE MEDIUM, AND ELECTRONIC DEVICE

(71) Applicant: CloudMinds (Shanghai) Robotics Co., Ltd., Shanghai (CN)

(72) Inventors: Zhaoxiang Liu, Guangdong (CN); Shiguo Lian, Guangdong (CN); Shaohua Li, Guangdong (CN)

(73) Assignee: CloudMinds (Shanghai) Robotics Co., Ltd., Shanghai (CN)

(21) Appl. No.: 17/320,662

(22) Filed: May 14, 2021

Related U.S. Application Data
(63) Continuation of application No. PCT/CN2019/118111, filed on Nov. 13, 2019.

(30) Foreign Application Priority Data
Nov. 27, 2018 (CN) 201811427358.7

(51) Int. Cl. G05D 1/02; G06K 9/00; G06K 9/62; G06K 9/46; G06N 3/04; G06N 3/08

(52) U.S. Cl. CPC G05D 1/0221; G06K 9/00805; G06K 9/6256; G05D 1/0088; G06N 3/04; G06N 3/08; G05D 1/0231; G06K 9/46

(57) ABSTRACT

A method and apparatus for controlling a device to move, a storage medium, and an electronic device. The method includes: collecting a first RGB-D image of a surrounding environment of a target device according to a preset period when the target device moves; obtaining a second RGB-D image of a preset number of frames from the first RGB-D image; obtaining a pre-trained deep Q network model DQN training model, and performing migration training on the DQN training model according to the second RGB-D image to obtain a target DQN model; obtaining a target RGB-D image of the current surrounding environment of the target device; inputting the target RGB-D image into the target DQN model to obtain a target output parameter, and determining a target control strategy according to the target output parameter; and controlling the target device to move according to the target control strategy.

### CROSS-REFERENCE TO RELATED APPLICATION

The present application is a continuation application under 35 U.S.C. § 120 of PCT application No. PCT/CN2019/118111, filed on Nov. 13, 2019, which claims foreign priority to Chinese Patent Application No. 201811427358.7, filed on Nov. 27, 2018, and the entire contents of each of which are incorporated herein by reference.

### TECHNICAL FIELD

The present disclosure relates to the field of navigation, and in particular, to a method and apparatus for controlling a device to move, a storage medium, and an electronic device.

### BACKGROUND

With the continuous advancement of science and technology, the automatic navigation technology of mobile devices such as unmanned vehicles, robots and the like has gradually become a research hotspot. In recent years, deep learning has been continuously developed, especially a convolutional neural network (CNN) in the deep learning has made great leap in the fields of target recognition, image classification and the like, and related technologies such as automatic driving and intelligent robot navigation based on deep learning are also emerging.

In the prior art, an end-to-end learning algorithm (such as DeepDriving technology, Nvidia technology and the like) is generally used to implement automatic navigation of the above mobile devices. However, this end-to-end learning algorithm requires manual labeling of samples, and a lot of manpower and material resources need to be consumed to collect the samples in actual training scenarios, so that the practicability and the universality of the existing navigation algorithm are worse.

### SUMMARY

The present disclosure provides a method and apparatus for controlling a device to move, a storage medium, and an electronic device.

According to a first aspect of the embodiments of the present disclosure, a method for controlling a device to move is provided, including: collecting a first RGB-D image of a surrounding environment of a target device according to a preset period when the target device moves; obtaining a second RGB-D image of a preset number of frames from the first RGB-D image; obtaining a pre-trained deep Q network model DQN training model, and performing migration training on the DQN training model according to the second RGB-D image to obtain a target DQN model; obtaining a target RGB-D image of the current surrounding environment of the target device; inputting the target RGB-D image into the target DQN model to obtain a target output parameter, and determining a target control strategy according to the target output parameter; and controlling the target device to move according to the target control strategy.

Optionally, the performing migration training on the DQN training model according to the second RGB-D image to obtain a target DQN model includes: using the second RGB-D image as the input of the DQN training model to obtain a first output parameter of the DQN training model; determining a first control strategy according to the first output parameter, and controlling the target device to move according to the first control strategy; obtaining relative position information of the target device and a surrounding obstacle; evaluating the first control strategy according to the relative position information to obtain a score value; obtaining a DQN check model, the DQN check model includes a DQN model generated according to model parameters of the DQN training model; and performing the migration training on the DQN training model according to the score value and the DQN check model to obtain the target DQN model.

Optionally, the DQN training model includes a convolutional layer and a full connection layer connected with the convolutional layer, and the using the second RGB-D image as the input of the DQN training model to obtain a first output parameter of the DQN training model includes: inputting the second RGB-D image of the preset number of frames into the convolutional layer to extract a first image feature, and inputting the first image feature into the full connection layer to obtain the first output parameter of the DQN training model.

Optionally, the DQN training model includes a plurality of convolutional neural networks CNN networks, a plurality of recurrent neural networks RNN networks, and a full connection layer, different CNN networks are connected with different RNN networks, a target RNN network of the RNN networks is connected with the full connection layer, the target RNN network includes any one of the RNN networks, the plurality of RNN networks are sequentially connected, and the using the second RGB-D image as the input of the DQN training model to obtain a first output parameter of the DQN training model includes: respectively inputting each frame of the second RGB-D image into different CNN networks to extract second image features; circularly performing a feature extraction step until a feature extraction termination condition is satisfied, the feature extraction step includes: inputting the second image features into a current RNN network connected with the CNN network, and obtaining a fourth image feature through the current RNN network according to the second image features and a third image feature input by the previous RNN network, and inputting the fourth image feature into the next RNN network; determining the next RNN network as an updated current RNN network; the feature extraction termination condition includes: obtaining a fifth image feature output by the target RNN network; and after the fifth image feature is obtained, inputting the fifth image feature into the full connection layer to obtain the first output parameter of the DQN training model.

Optionally, the performing the migration training on the DQN training model according to the score value and the DQN check model to obtain the target DQN model includes: obtaining a third RGB-D image of the current surrounding environment of the target device; inputting the third RGB-D image into the DQN check model to obtain a second output parameter; performing calculation according to the score value and the second output parameter to obtain an expected output parameter; obtaining a training error according to the first output parameter and the expected output parameter; and obtaining a preset error function, and training the DQN training model according to the training error and the preset error function in accordance with a counterpropagation algorithm to obtain the target DQN model.

Optionally, the inputting the target RGB-D image into the target DQN model to obtain a target output parameter includes: inputting the target RGB-D image into the target DQN model to obtain a plurality of to-be-determined output parameters; and determining a maximum parameter among the plurality of to-be-determined output parameters as the target output parameter.

According to a second aspect of the embodiments of the present disclosure, an apparatus for controlling a device to move is provided, including: an image collection module, configured to collect a first RGB-D image of a surrounding environment of a target device according to a preset period when the target device moves; a first obtaining module, configured to obtain a second RGB-D image of a preset number of frames from the first RGB-D image; a training module, configured to obtain a pre-trained deep Q network model DQN training model, and perform migration training on the DQN training model according to the second RGB-D image to obtain a target DQN model; a second obtaining module, configured to obtain a target RGB-D image of the current surrounding environment of the target device; a determining module, configured to input the target RGB-D image into the target DQN model to obtain a target output parameter, and determine a target control strategy according to the target output parameter; and a control module, configured to control the target device to move according to the target control strategy.

Optionally, the training module includes: a first determining sub-module, configured to use the second RGB-D image as the input of the DQN training model to obtain a first output parameter of the DQN training model; a control sub-module, configured to determine a first control strategy according to the first output parameter, and control the target device to move according to the first control strategy; a first obtaining sub-module, configured to obtain relative position information of the target device and a surrounding obstacle; a second determining sub-module, configured to evaluate the first control strategy according to the relative position information to obtain a score value; a second obtaining sub-module, configured to obtain a DQN check model, the DQN check model includes a DQN model generated according to model parameters of the DQN training model; and a training sub-module, configured to perform the migration training on the DQN training model according to the score value and the DQN check model to obtain the target DQN model.

Optionally, the DQN training model includes a convolutional layer and a full connection layer connected with the convolutional layer, and the first determining sub-module is configured to input the second RGB-D image of the preset number of frames into the convolutional layer to extract a first image feature, and input the first image feature into the full connection layer to obtain the first output parameter of the DQN training model.

Optionally, the DQN training model includes a plurality of convolutional neural networks CNN networks, a plurality of recurrent neural networks RNN networks, and a full connection layer, different CNN networks are connected with different RNN networks, a target RNN network of the RNN networks is connected with the full connection layer, the target RNN network includes any one of the RNN networks, the plurality of RNN networks are sequentially connected, and the first determining sub-module is configured to respectively input each frame of the second RGB-D image into different CNN networks to extract second image features; circularly perform a feature extraction step until a feature extraction termination condition is satisfied, the feature extraction step includes: inputting the second image features into a current RNN network connected with the CNN network, and obtaining a fourth image feature through the current RNN network according to the second image features and a third image feature input by the previous RNN network, and inputting the fourth image feature into the next RNN network; determining the next RNN network as an updated current RNN network; the feature extraction termination condition includes: obtaining a fifth image feature output by the target RNN network; and after the fifth image feature is obtained, inputting the fifth image feature into the full connection layer to obtain the first output parameter of the DQN training model.

Optionally, the training sub-module is configured to obtain a third RGB-D image of the current surrounding environment of the target device; input the third RGB-D image into the DQN check model to obtain a second output parameter; perform calculation according to the score value and the second output parameter to obtain an expected output parameter; obtain a training error according to the first output parameter and the expected output parameter; and obtain a preset error function, and train the DQN training model according to the training error and the preset error function in accordance with a counterpropagation algorithm to obtain the target DQN model.

Optionally, the determining module includes: a third determining sub-module, configured to input the target RGB-D image into the target DQN model to obtain a plurality of to-be-determined output parameters; and a fourth determining sub-module, configured to determine a maximum parameter among the plurality of to-be-determined output parameters as the target output parameter.

According to a third aspect of the embodiments of the present disclosure, a computer readable storage medium is provided, a computer program is stored thereon, and the program, when executed by a processor, implements the steps of the method in the first aspect of the present disclosure.

According to a fourth aspect of the embodiments of the present disclosure, an electronic device is provided, including: a memory, wherein a computer program is stored thereon; and a processor, configured to execute the computer program in the memory to implement the steps of the method in the first aspect of the present disclosure.

Through the above technical solutions, by collecting the first RGB-D image of the surrounding environment of the target device according to the preset period when the target device moves; obtaining the second RGB-D image of the preset number of frames from the first RGB-D image; obtaining the pre-trained deep Q network model DQN training model, and performing the migration training on the DQN training model according to the second RGB-D image to obtain the target DQN model; obtaining the target RGB-D image of the current surrounding environment of the target device; inputting the target RGB-D image into the target DQN model to obtain the target output parameter, and determining the target control strategy according to the target output parameter; and controlling the target device to move according to the target control strategy, the target device may autonomously learn the control strategy through the deep Q network (Deep Q Network, DQN) model without manual labeling of samples, thereby improving the versatility of the model while saving the manpower and material resources.

Other features and advantages of the present disclosure will be described in detail in the detailed description of the embodiments that follows.

### BRIEF DESCRIPTION OF THE DRAWINGS

The drawings are used for providing a further understanding of the present disclosure and constitute a part of the specification. The drawings, together with the following specific embodiments, are used for explaining the present disclosure, but do not constitute limitation to the present disclosure. In the drawings:

FIG. 1 is a flow diagram of a method for controlling a device to move shown according to an exemplary embodiment;

FIG. 2 is a flow diagram of another method for controlling a device to move shown according to an exemplary embodiment;

FIG. 3 is a structural schematic diagram of a DQN model shown according to an exemplary embodiment;

FIG. 4 is a structural schematic diagram of another DQN model shown according to an exemplary embodiment;

FIG. 5 is a block diagram of a first apparatus for controlling a device to move shown according to an exemplary embodiment;

FIG. 6 is a block diagram of a second apparatus for controlling a device to move shown according to an exemplary embodiment;

FIG. 7 is a block diagram of a third apparatus for controlling a device to move shown according to an exemplary embodiment;

FIG. 8 is a block diagram of an electronic device shown according to an exemplary embodiment.

### DETAILED DESCRIPTION

The specific embodiments of the present disclosure will be described in detail below in combination with the drawings. It should be understood that the specific embodiments described herein are merely used for illustrating and explaining the present disclosure, rather than limiting the present disclosure.

The present disclosure provides a method and apparatus for controlling a device to move, a storage medium, and an electronic device. By collecting a first RGB-D image of a surrounding environment of a target device according to a preset period when the target device moves; obtaining a second RGB-D image of a preset number of frames from the first RGB-D image; obtaining a pre-trained deep Q network model DQN training model, and performing migration training on the DQN training model according to the second RGB-D image to obtain a target DQN model; obtaining a target RGB-D image of the current surrounding environment of the target device; inputting the target RGB-D image into the target DQN model to obtain a target output parameter, and determining a target control strategy according to the target output parameter; and controlling the target device to move according to the target control strategy, the target device may autonomously learn the control strategy through the deep Q network (DQN) model without manual labeling of samples, thereby improving the versatility of the model while saving the manpower and material resources.

The specific embodiments of the present disclosure will be described in detail below in combination with the drawings.

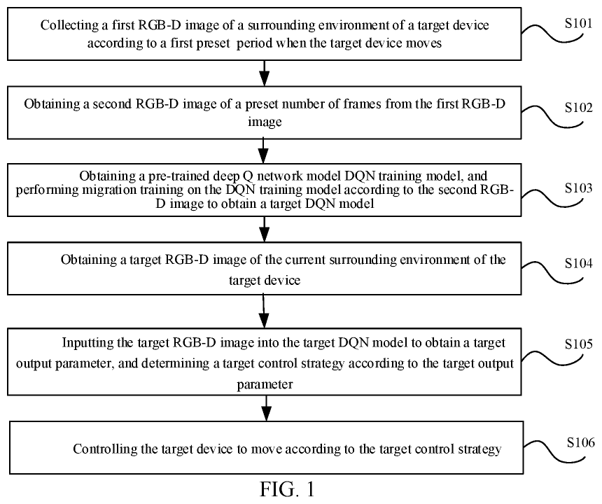

FIG. 1 is a flow diagram of a method for controlling a device to move shown according to an exemplary embodiment. As shown in FIG. 1, the method includes the following steps:

S101, a first RGB-D image of a surrounding environment of a target device is collected according to a first preset period, when the target device moves.

Wherein, the target device may include a mobile device such as a robot, an autonomous vehicle or the like, the RGB-D image may be an RGB-D four-channel image including both RGB color image features and depth image features, and the RGB-D image may provide richer information for navigation decision making compared with the traditional RGB images.

In a possible implementation manner, the first RGB-D image of the surrounding environment of the target device may be collected by an RGB-D image collection apparatus (e.g., an RGB-D camera or a binocular camera) according to the preset period.

S102, a second RGB-D image of a preset number of frames is obtained from the first RGB-D image.

Considering that the purpose of the present disclosure is to determine a navigation control strategy of the target device according to the latest collected image information of the surrounding environment of the target device, therefore, in a possible implementation manner, multiple frames of RGB-D image sequences implicitly containing position and speed information of an obstacle in the surrounding environment of the target device may be input, and the multiple frames of RGB-D image sequences are the second RGB-D image of the preset number of frames.

S103, a pre-trained deep Q network model DQN training model is obtained, and migration training is performed on the DQN training model according to the second RGB-D image to obtain a target DQN model.

Since the training process of the deep Q network model is realized through trial and feedback, that is, the target device encounters collision and other dangerous situations in a learning process, therefore, in order to improve the safety factor of the deep Q network model during navigation, in a possible implementation manner, pre-training may be performed in a simulation environment to obtain the DQN training model, for example, the pre-training process of an automatic driving navigation model may be completed by adopting an automatic driving simulation environment such as AirSim or CARLA, and an automatic navigation model of a robot may also be pre-trained by using a Gazebo robot simulation environment.

In addition, considering the difference between the simulation environment and the real environment, for example, the lighting conditions, image textures and the like of the simulation environment are different from those of the real environment, so RGB-D images collected in the real environment are different from the RGB-D images collected in the simulation environment in the aspects of brightness, textures and other image features, in this way, if the DQN training model obtained by the training in the simulation environment is directly applied to the real environment for navigation, the error of using the DQN training model in the real environment for navigation is relatively large, at this time, in order that the DQN training model can be applicable to the real environment, in a possible implementation manner, the RGB-D image of the real environment may be collected, and the RGB image collected in the real environment is used as the input of the DQN training model, migration training is performed on the DQN training model to obtain the target DQN model applicable to the real environment, in this way, the training speed of the entire network may be accelerated while reducing the difficulty of the model training.

In this step, the second RGB-D image may be used as the input of the DQN training model to obtain a first output parameter of the DQN training model; a first control strategy is determined according to the first output parameter, and the target device is controlled to move according to the first control strategy; relative position information of the target device and a surrounding obstacle is obtained; the first control strategy is evaluated according to the relative position information to obtain a score value; a DQN check model is obtained, wherein the DQN check model includes a DQN model generated according to model parameters of the DQN training model; and the migration training is performed on the DQN training model according to the score value and the DQN check model to obtain the target DQN model.

Wherein, the first output parameter may include a maximum parameter among a plurality of to-be-determined output parameters, and an output parameter may also be randomly selected from the plurality of to-be-determined output parameters to serve as the first output parameter (such that the generalization ability of the DQN model may be improved), the output parameter may include a Q value output by the DQN model, and the to-be-determined output parameters may include Q values respectively corresponding to a plurality of preset control strategies (such as acceleration, deceleration, braking, left turning, right turning and the like); the relative position information may include distance information or angle information of the target device and the obstacle around the target device; and the DQN check model is used to update an expected output parameter of the model in a training process of the DQN model.

When the second RGB-D image is used as the input of the DQN training model to obtain the first output parameter of the DQN training model, it may be implemented in any one of the following two manners:

In a first mode, the DQN training model may include a convolutional layer and a full connection layer connected with the convolutional layer, based on a model structure of the DQN training model in the first mode, the second RGB-D image of the preset number of frames may be input into the convolutional layer to extract a first image feature, and the first image feature is input into the full connection layer to obtain the first output parameter of the DQN training model.

In a second mode, the DQN training model may include a plurality of convolutional neural networks (Convolutional Neural Network, CNN) CNN networks, a plurality of recurrent neural networks (Recurrent Neural Network, RNN) RNN networks, and a full connection layer, different CNN networks are connected with different RNN networks, a target RNN network of the RNN networks is connected with the full connection layer, the target RNN network includes any one of the RNN networks, the plurality of RNN networks are sequentially connected, based on the model structure of the DQN training model in the second mode, each frame of the second RGB-D image may be respectively input into different CNN networks to extract second image features; a feature extraction step is circularly performed until a feature extraction termination condition is satisfied, wherein the feature extraction step includes: inputting the second image features into a current RNN network connected with the CNN network, and obtaining a fourth image feature through the current RNN network according to the second image features and a third image feature input by the previous RNN network, and inputting the fourth image feature into the next RNN network; determining the next RNN network as an updated current RNN network; the feature extraction termination condition includes: obtaining a fifth image feature output by the target RNN network; and after the fifth image feature is obtained, inputting the fifth image feature into the full connection layer to obtain the first output parameter of the DQN training model.

Wherein, the RNN may include a long short-term memory (Long Short-Term Memory, LSTM).

It should be noted that a conventional convolutional neural network includes a convolutional layer and a pooling layer connected with the convolutional layer, the convolutional layer is used for extracting image features, the pooling layer is used for performing dimension reduction processing (e.g., mean value sampling or maximum value sampling) on the image features extracted by the convolutional layer, the CNN convolutional neural network in the DQN model structure of the second mode does not include the pooling layer, so that all image features extracted by the convolutional layer may be retained, thereby providing more reference information for determining the optimal navigation control strategy for the model, and improving the accuracy of model navigation.

In addition, when the migration training is performed on the DQN training model according to the score value and the DQN check model to obtain the target DQN model, a third RGB-D image of the current surrounding environment of the target device may be obtained; the third RGB-D image is input into the DQN check model to obtain a second output parameter; calculation is performed according to the score value and the second output parameter to obtain an expected output parameter; a training error is obtained according to the first output parameter and the expected output parameter; and a preset error function is obtained, and the DQN training model is trained according to the training error and the preset error function in accordance with a counterpropagation algorithm to obtain the target DQN model.

Wherein, the third RGB-D image may include the RGB-D image collected after controlling the target device to move according to the first control strategy, and the second output parameter may include a maximum parameter among a plurality of to-be-determined output parameters output by the DQN check model.

It should further be noted that, after the target device is powered on, the RGB-D image collection apparatus of the target device may collect the RGB-D image of the surrounding environment of the target device according to the preset period, and may also determine the control strategy according to the latest collected RGB-D image of the preset number of frames through the DQN training model, before obtaining the target DQN model via the migration training, so as to control the target device to start.

S104, a target RGB-D image of the current surrounding environment of the target device is obtained.

S105, the target RGB-D image is input into the target DQN model to obtain a target output parameter, and a target control strategy is determined according to the target output parameter.

In this step, the target RGB-D image may be input into the target DQN model to obtain a plurality of to-be-determined output parameters; and a maximum parameter among the plurality of to-be-determined output parameters is determined as the target output parameter.

S106, the target device is controlled to move according to the target control strategy.

By adopting the above method, the target device may autonomously learn the control strategy through the deep Q network model without manual labeling of samples, thereby improving the versatility of the model while saving the manpower and material resources.

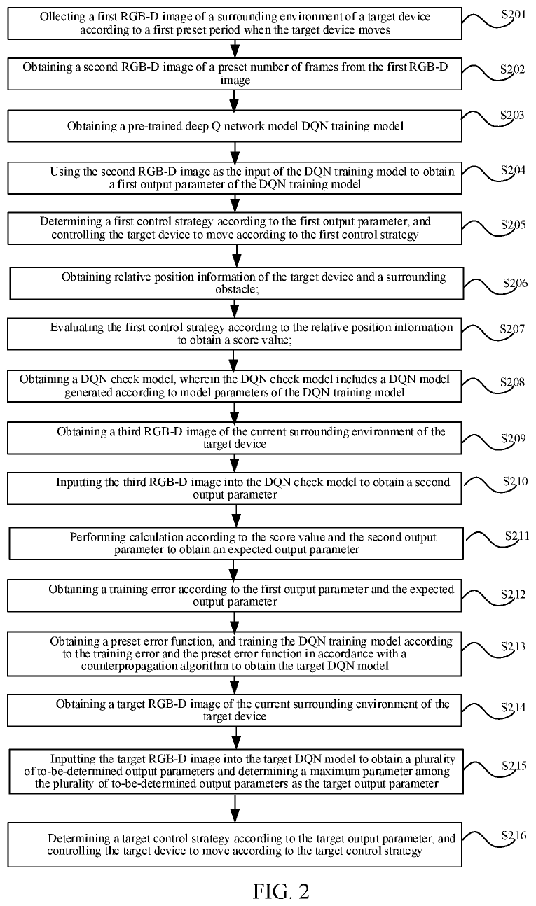

FIG. 2 is a flow diagram of a method for controlling a device to move shown according to an exemplary embodiment. As shown in FIG. 2, the method includes the following steps:
S201, a first RGB-D image of a surrounding environment of a target device is collected according to a first preset period, when the target device moves.

Wherein, the target device may include a mobile device such as a robot, an autonomous vehicle or the like, the RGB-D image may be an RGB-D four-channel image including both RGB color image features and depth image features, and the RGB-D image may provide richer information for navigation decision making compared with the traditional RGB images.

In a possible implementation manner, the first RGB-D image of the surrounding environment of the target device may be collected by an RGB-D image collection apparatus (e.g., an RGB-D camera or a binocular camera) according to the preset period.

S202, a second RGB-D image of a preset number of frames is obtained from the first RGB-D image.

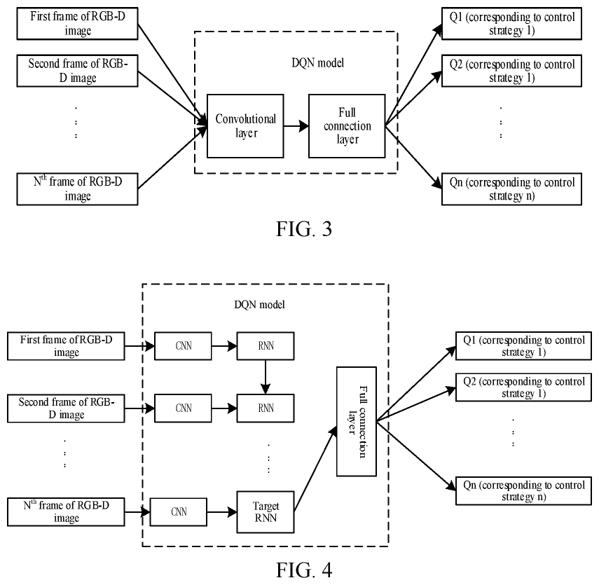

Considering that the purpose of the present disclosure is to determine a navigation control strategy of the target device according to the latest collected image information of the surrounding environment of the target device, therefore, in a possible implementation manner, multiple frames of RGB-D image sequences implicitly containing position and speed information of an obstacle in the surrounding environment of the target device may be input, and the multiple frames of RGB-D image sequences are the second RGB-D image of the preset number of frames, for example, as shown in FIG. 3 and FIG. 4, the second RGB-D image of the preset number of frames includes a first frame of RGB-D image, a second frame of RGB-D image, . . . , an n^{th} frame of RGB-D image.

S203, a pre-trained deep Q network model DQN training model is obtained.

Since the training process of the deep Q network model is realized through trial and feedback, that is, the target device encounters collision and other dangerous situations in a learning process, therefore, in order to improve the safety factor of the deep Q network model during navigation, in a possible implementation manner, pre-training may be performed in a simulation environment to obtain the DQN training model, for example, the pre-training process of an automatic driving navigation model may be completed by adopting an automatic driving simulation environment such as AirSim or CARLA, and an automatic navigation model of a robot may also be pre-trained by using a Gazebo robot simulation environment.

In addition, considering the difference between the simulation environment and the real environment, for example, the lighting conditions, image textures and the like of the simulation environment are different from those of the real environment, so RGB-D images collected in the real environment are different from the RGB-D images collected in the simulation environment in the aspects of brightness, textures and other image features, in this way, if the DQN training model obtained by the training in the simulation environment is directly applied to the real environment for navigation, the error of using the DQN training model in the real environment for navigation is relatively large, at this time, in order that the DQN training model can be applicable to the real environment, in a possible implementation manner, the RGB-D image of the real environment may be collected, and the RGB image collected in the real environment is used as the input of the DQN training model, migration training is performed on the DQN training model to obtain the target DQN model applicable to the real environment, in this way, the training speed of the entire network may be accelerated while reducing the difficulty of the model training.

In the present embodiment, the migration training may be performed on the DQN training model by executing S204 to S213 to determine the target DQN model.

S204, the second RGB-D image is used as the input of the DQN training model to obtain a first output parameter of the DQN training model.

Wherein, the first output parameter may include a maximum parameter among a plurality of to-be-determined output parameters, and an output parameter may also be randomly selected from the plurality of to-be-determined output parameters to serve as the first output parameter (such that the generalization ability of the DQN model may be improved), the output parameter may include a Q value output by the DQN model, and the to-be-determined output parameters may include Q values respectively corresponding to a plurality of preset control strategies (such as acceleration, deceleration, braking, left turning, right turning and the like).

The present step may be implemented in any one of the following two manners:

In a first mode, as shown in FIG. 3, the DQN training model may include a convolutional layer and a full connection layer connected with the convolutional layer, based on a model structure of the DQN training model in the first mode, the second RGB-D image of the preset number of frames may be input into the convolutional layer to extract a first image feature, and the first image feature is input into the full connection layer to obtain the first output parameter of the DQN training model.

For example, as shown in FIG. 3, N frames of RGB-D images (that is, the first frame of RGB-D image, the second frame of RGB-D image, . . . , the n^{th} frame of RGB-D image as shown in FIG. 3) are input into the convolutional layer of the DQN training model; and in addition, since each frame of RGB-D image is a four-channel image, based on the structure of the DQN model as shown in FIG. 3, RGB-D image information of N*4 channels may be stacked and input into the convolutional layer to extract image features, in this way, the DQN model may determine the optimal control strategy based on richer image features.

In a second mode, as shown in FIG. 4, the DQN training model may include a plurality of convolutional neural networks CNN networks, a plurality of recurrent neural networks RNN networks, and a full connection layer, different CNN networks are connected with different RNN networks, a target RNN network of the RNN networks is connected with the full connection layer, the target RNN network includes any one of the RNN networks, the plurality of RNN networks are sequentially connected, based on the model structure of the DQN training model in the second mode, each frame of the second RGB-D image may be respectively input into different CNN networks to extract second image features; a feature extraction step is circularly performed until a feature extraction termination condition is satisfied, wherein the feature extraction step includes: inputting the second image features into a current RNN network connected with the CNN network, and obtaining a fourth image feature through the current RNN network according to the second image features and a third image feature input by the previous RNN network, and inputting the fourth image feature into the next RNN network; determining the next RNN network as an updated current RNN network; the feature extraction termination condition includes: obtaining a fifth image feature output by the target RNN network; and after the fifth image feature is obtained, inputting the fifth image feature into the full connection layer to obtain the first output parameter of the DQN training model.

Wherein, the RNN may include a long short-term memory LSTM.

It should be noted that a conventional convolutional neural network includes a convolutional layer and a pooling layer connected with the convolutional layer, the convolutional layer is used for extracting image features, the pooling layer is used for performing dimension reduction processing (e.g., mean value sampling or maximum value sampling) on the image features extracted by the convolutional layer, the CNN convolutional neural network in the DQN model structure of the second mode does not include the pooling layer, so that all image features extracted by the convolutional layer may be retained, thereby providing more reference information for determining the optimal navigation control strategy for the model, and improving the accuracy of model navigation.

S205, a first control strategy is determined according to the first output parameter, and the target device is controlled to move according to the first control strategy.

Exemplarily, illustration is given by taking it as an example that the preset control strategy includes three control strategies: left turn, right turn and acceleration, wherein the output parameter corresponding to left turn is Q1, the output parameter corresponding to right turn is Q2, and the output parameter corresponding to acceleration is Q3, when the first output parameter is Q1, the first control strategy may be determined as left turn corresponding to Q1, at this time, the target device may be controlled to turn left, the above example is only an example, and this is not limited in the present disclosure.

S206, relative position information of the target device and a surrounding obstacle is obtained.

Wherein, the relative position information may include distance information or angle information or the like of the target device and the obstacle around the target device.

In a possible implementation manner, the relative position information may be obtained by a collision detection sensor.

S207, the first control strategy is evaluated according to the relative position information to obtain a score value.

In a possible implementation manner, the first control strategy may be evaluated according to a preset scoring rule to obtain the score value, and the preset scoring rule may be specifically set according to an actual application scenario.

For example, when the target device is an autonomous vehicle, and when the relative position information is distance information of the vehicle and the surrounding obstacle, the preset scoring rule may be: when it is determined that the distance between the vehicle and the obstacle is greater than or equal to 10 m, the score value is 10 points; when it is determined that the distance between the vehicle and the obstacle is greater than or equal to 5 m and is less than 10 m, the score value is 5 points; when it is determined that the distance between the vehicle and the obstacle is greater than 3 m and is less than 5 m, the score value is 3 points; when it is determined that the distance between the vehicle and the obstacle is less than or equal to 3 m, the score value is 0 point; and at this time, after the vehicle is controlled to move according to the first control strategy, the score value may be determined according to the distance information of the vehicle and the obstacle based on the preset scoring rule. In addition, when the relative position information is the angle information of the vehicle and the surrounding obstacle, the preset scoring rule may be: when it is determined that the angle of the vehicle relative to the obstacle is greater than or equal to 30 degrees, the score value is 10 points; when it is determined that the angle of the vehicle relative to the obstacle is greater than or equal to 15 degrees and is less than 30 degrees, the score value is 5 points; when it is determined that the angle of the vehicle relative to the obstacle is less than or equal to 15 degrees, the score value 0 point, at this time, after the vehicle is controlled to move according to the first control strategy, the score value may be determined according to the angle information of the vehicle and the obstacle based on the preset scoring rule, the above description is merely an example, and this is not limited in the present disclosure.

S208, a DQN check model is obtained, the DQN check model includes a DQN model generated according to model parameters of the DQN training model.

Wherein, the DQN check model is used for updating an expected output parameter of the model in a training process of the DQN model.

When the DQN check model is generated, the model parameters of the DQN training model obtained by pre-training may be assigned to the DQN check model at the initial time, then the model parameters of the DQN training model are updated by migration training, and then the latest updated model parameters of the DQN training model may be assigned to the DQN check model at intervals of preset time period to update the DQN check model.

S209, a third RGB-D image of the current surrounding environment of the target device is obtained.

Wherein, the third RGB-D image may include the RGB-D image collected after controlling the target device to move according to the first control strategy.

S210, the third RGB-D image is input into the DQN check model to obtain a second output parameter.

Wherein, the second output parameter may include a maximum parameter among a plurality of to-be-determined output parameters output by the DQN check model.

S211, calculation is performed according to the score value and the second output parameter to obtain an expected output parameter.

In this step, the expected output parameter may be determined according to the score value and the second output parameter by the following formula.

Qₒ=r+γ MAXₐQ(sₜ₊₁, a)

Wherein, Qₒ represents the expected output parameter, r represents the score value, γ represents an adjustment factor, sₜ₊₁ represents the third RGB-D image, Q(sₜ₊₁, a) represents a plurality of to-be-determined output parameters obtained after the third RGB-D image of a preset number of frames is input into the DQN check model, MAXₐQ(sₜ₊₁, a) represents the second output parameter (that is, the maximum parameter among the plurality of to-be-determined output parameters), and a represents the second control strategy corresponding to the second output parameter.

It should be noted that, in a possible implementation manner, when the second output parameter is the maximum parameter among the plurality of to-be-determined output parameters, the second control strategy is the optimal control strategy obtained after the third RGB-D image is input into the DQN check model.

S212, a training error is obtained according to the first output parameter and the expected output parameter.

In this step, a square of a difference value between the first output parameter and the expected output parameter may be determined as the training error.

S213, a preset error function is obtained, and the DQN training model is trained according to the training error and the preset error function in accordance with a counterpropagation algorithm to obtain the target DQN model.

For the specific implementation manner of this step, reference may be made to related descriptions in the prior art, and details are not described herein again.

After the target DQN model is obtained, the target control strategy may be determined according to the target output parameter output by the target DQN model by performing S214 to S216, and the target device is controlled to move according to the target control strategy, thereby controlling the target device to move.

S214, a target RGB-D image of the current surrounding environment of the target device is obtained.

S215, the target RGB-D image is input into the target DQN model to obtain a plurality of to-be-determined output parameters, and a maximum parameter among the plurality of to-be-determined output parameters is determined as the target output parameter.

S216, a target control strategy is determined according to the target output parameter, and the target device is controlled to move according to the target control strategy.

By adopting the above method, the target device may autonomously learn the control strategy through the deep Q network model without manual labeling of samples, thereby improving the versatility of the model while saving the manpower and material resources.

FIG. 5 is a block diagram of an apparatus for controlling a device to move shown according to an exemplary embodiment. As shown in FIG. 5, the apparatus includes:
an image collection module 501, configured to collect a first RGB-D image of a surrounding environment of a target device according to a preset period when the target device moves;
a first obtaining module 502, configured to obtain a second RGB-D image of a preset number of frames from the first RGB-D image;
a training module 503, configured to obtain a pre-trained deep Q network model DQN training model, and perform migration training on the DQN training model according to the second RGB-D image to obtain a target DQN model;
a second obtaining module 504, configured to obtain a target RGB-D image of the current surrounding environment of the target device;
a determining module 505, configured to input the target RGB-D image into the target DQN model to obtain a target output parameter, and determine a target control strategy according to the target output parameter; and
a control module 506, configured to control the target device to move according to the target control strategy.

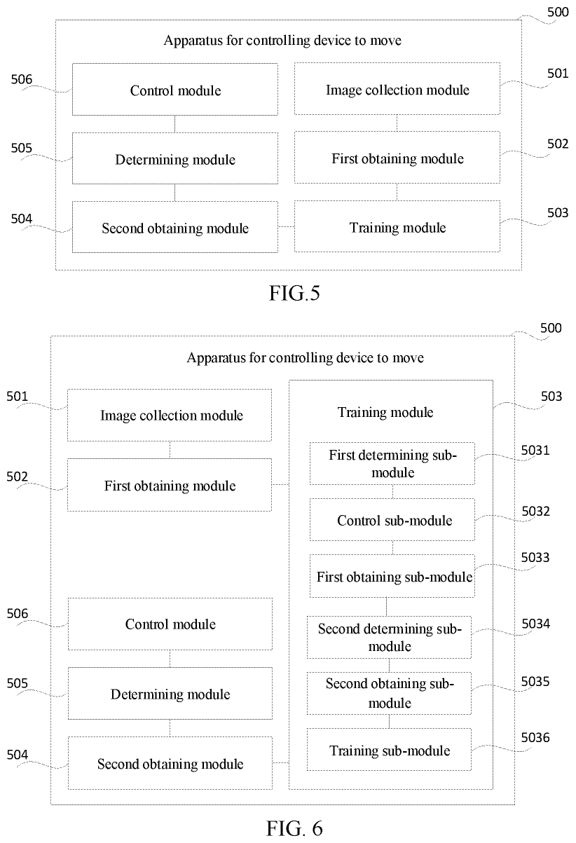

Optionally, FIG. 6 is a block diagram of an apparatus for controlling a device to move shown according to the embodiment shown in FIG. 5, and as shown in FIG. 6, the training module 503 includes:
a first determining sub-module 5031, configured to use the second RGB-D image as the input of the DQN training model to obtain a first output parameter of the DQN training model;
a control sub-module 5032, configured to determine a first control strategy according to the first output parameter, and control the target device to move according to the first control strategy;
a first obtaining sub-module 5033, configured to obtain relative position information of the target device and a surrounding obstacle;
a second determining sub-module 5034, configured to evaluate the first control strategy according to the relative position information to obtain a score value;
a second obtaining sub-module 5035, configured to obtain a DQN check model, the DQN check model includes a DQN model generated according to model parameters of the DQN training model; and
a training sub-module 5036, configured to perform the migration training on the DQN training model according to the score value and the DQN check model to obtain the target DQN model.

Optionally, the DQN training model includes a convolutional layer and a full connection layer connected with the convolutional layer, and the first determining sub-module 5031 is configured to input the second RGB-D image of the preset number of frames into the convolutional layer to extract a first image feature, and input the first image feature into the full connection layer to obtain the first output parameter of the DQN training model.

Optionally, the DQN training model includes a plurality of convolutional neural networks CNN networks, a plurality of recurrent neural networks RNN networks, and a full connection layer, different CNN networks are connected with different RNN networks, a target RNN network of the RNN networks is connected with the full connection layer, the target RNN network includes any one of the RNN networks, the plurality of RNN networks are sequentially connected, and the first determining sub-module 5031 is configured to respectively input each frame of the second RGB-D image into different CNN networks to extract second image features; circularly perform a feature extraction step until a feature extraction termination condition is satisfied, the feature extraction step includes: inputting the second image features into a current RNN network connected with the CNN network, and obtaining a fourth image feature through the current RNN network according to the second image features and a third image feature input by the previous RNN network, and inputting the fourth image feature into the next RNN network; determining the next RNN network as an updated current RNN network; the feature extraction termination condition includes: obtaining a fifth image feature output by the target RNN network; and after the fifth image feature is obtained, inputting the fifth image feature into the full connection layer to obtain the first output parameter of the DQN training model.

Optionally, the training sub-module 5036 is configured to obtain a third RGB-D image of the current surrounding environment of the target device; input the third RGB-D image into the DQN check model to obtain a second output parameter; perform calculation according to the score value and the second output parameter to obtain an expected output parameter; obtain a training error according to the first output parameter and the expected output parameter; and obtain a preset error function, and train the DQN training model according to the training error and the preset error function in accordance with a counterpropagation algorithm to obtain the target DQN model.

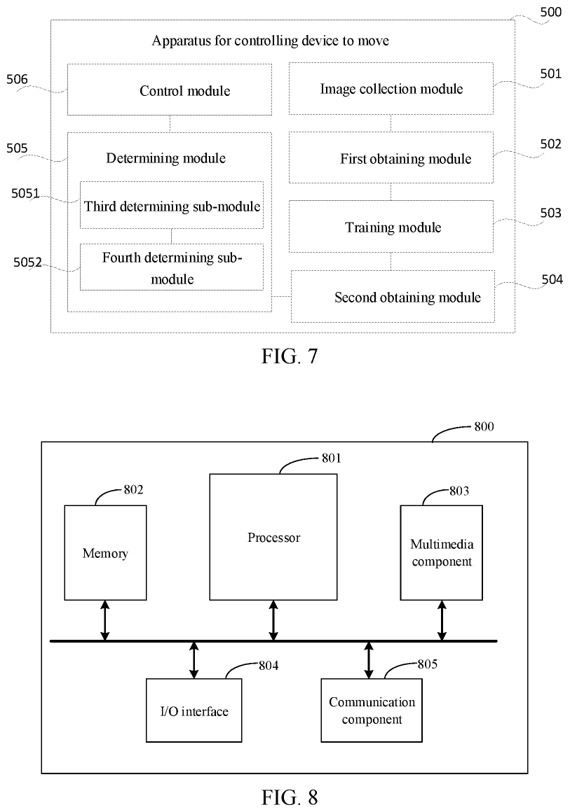

Optionally, FIG. 7 is a block diagram of an apparatus for controlling a device to move shown according to the embodiment shown in FIG. 5, and as shown in FIG. 7, the determining module 505 includes:
a third determining sub-module 5051, configured to input the target RGB-D image into the target DQN model to obtain a plurality of to-be-determined output parameters; and
a fourth determining sub-module 5052, configured to determine a maximum parameter among the plurality of to-be-determined output parameters as the target output parameter.

With regard to the apparatus in the above embodiments, the specific manners in which the respective modules perform the operations have been described in detail in the embodiments related to the method, and thus will not be explained in detail herein.

By adopting the above apparatus, the target device may autonomously learn the control strategy through the deep Q network model without manual labeling of samples, thereby improving the versatility of the model while saving the manpower and material resources.

FIG. 8 is a block diagram of an electronic device shown according to an exemplary embodiment. As shown in FIG. 8, the electronic device 800 may include a processor 801 and a memory 802. The electronic device 800 may further include one or more of a multimedia component 803, an input/output (I/O) interface 804, and a communication component 805.

The processor 801 is configured to control the overall operation of the electronic device 800 to complete all or a part of steps of the method for controlling the device to move. The memory 802 is configured to store various types of data to support the operations at the electronic device 800, these data may include, for example, instructions for any application program or method operated on the electronic device 800, as well as data related to the application program, for example, contact data, sent and received messages, pictures, audio, videos, and so on. The memory 802 may be implemented by any type of volatile or non-volatile storage devices or a combination thereof, such as a static random access memory (Static Random Access Memory, referred to as SRAM), an electrically erasable programmable read-only memory (Electrically Erasable Programmable Read-Only Memory, referred to as EEPROM), an erasable programmable read-only memory (Erasable Programmable Read-Only Memory, referred to as EPROM), a programmable read-only memory (Programmable Read-Only Memory, referred to as PROM), a read-only memory (Read-Only Memory, referred to as ROM), a magnetic memory, a flash memory, a disk or an optical disk. The multimedia component 803 may include a screen and an audio component. Wherein the screen may be, for example, a touch screen, and the audio component is configured to output and/or input an audio signal. For example, the audio component may include a microphone, and the microphone is configured to receive an external audio signal. The received audio signal may be further stored in the memory 802 or transmitted by the communication component 805. The audio component further includes at least one loudspeaker for outputting the audio signal. The I/O interface 804 provides an interface between the processor 801 and other interface modules. The above other interface modules may be keyboards, mice, buttons, and the like. These buttons may be virtual buttons or physical buttons. The communication component 805 is used for wired or wireless communication between the electronic device 800 and other devices. The wireless communication includes, such as Wi-Fi, Bluetooth, near field communication (Near Field Communication, referred to as NFC), 2G, 3G or 4G, or a combination of one or more of them, so the corresponding communication component 805 may include: a Wi-Fi module, a Bluetooth module, and an NFC module.

In an exemplary embodiment, the electronic device 800 may be configured by one or more application specific integrated circuits (Application Specific Integrated Circuits, referred to as ASICs), digital signal processors (Digital Signal Processors, referred to as DSPs), digital signal processing devices (Digital Signal Processing Devices, referred to as DSPDs), programmable logic devices (Programmable Logic Devices, referred to as PLDs), field programmable gate array (Field Programmable Gate Arrays, referred to as FPGAs), controllers, microcontrollers, microprocessors or other electronic components, so as to perform the method for controlling the device to move as described above.

In another exemplary embodiment, a computer readable storage medium including program instructions is further provided, and the program instructions, when executed by a processor, implements the steps of the method for controlling the device to move as described above. For example, the computer readable storage medium may be the above memory 802 including the program instructions, and the above program instructions may be executed by the processor 801 of the electronic device 800 to perform the method for controlling the device to move as described above.

The preferred embodiments of the present disclosure have been described in detail above with reference to the drawings. However, the present disclosure is not limited to the specific details in the above embodiments, various simple modifications may be made to the technical solutions of the present disclosure within the scope of the technical idea of the present disclosure, and these simple variations are all within the protection scope of the present disclosure.

It should be further noted that the specific technical features described in the above specific embodiments may be combined in any suitable manner without contradiction. In order to avoid unnecessary repetition, various possible combination manners are not described separately in the present disclosure.

In addition, any combination of various different embodiments of the present disclosure may be made as long as it does not contradict the idea of the present disclosure, and it should also be regarded as the contents disclosed by the present disclosure.

What is claimed is:

1. A method for controlling a device to move, comprising:
collecting a first RGB-D image of a surrounding environment of a target device according to a preset period when the target device moves;
obtaining a second RGB-D image of a preset number of frames from the first RGB-D image;
obtaining a pre-trained deep Q network model DQN training model, and performing migration training on the DQN training model according to the second RGB-D image to obtain a target DQN model;
obtaining a target RGB-D image of the current surrounding environment of the target device;
inputting the target RGB-D image into the target DQN model to obtain a target output parameter, and determining a target control strategy according to the target output parameter; and
controlling the target device to move according to the target control strategy.

2. The method according to claim 1, wherein the performing migration training on the DQN training model according to the second RGB-D image to obtain a target DQN model comprises:
using the second RGB-D image as the input of the DQN training model to obtain a first output parameter of the DQN training model;
determining a first control strategy according to the first output parameter, and controlling the target device to move according to the first control strategy;
obtaining relative position information of the target device and a surrounding obstacle;
evaluating the first control strategy according to the relative position information to obtain a score value;
obtaining a DQN check model, the DQN check model comprises a DQN model generated according to model parameters of the DQN training model; and
performing the migration training on the DQN training model according to the score value and the DQN check model to obtain the target DQN model.

3. The method according to claim 2, wherein the DQN training model comprises a convolutional layer and a full connection layer connected with the convolutional layer, and the using the second RGB-D image as the input of the DQN training model to obtain a first output parameter of the DQN training model comprises:
inputting the second RGB-D image of the preset number of frames into the convolutional layer to extract a first image feature, and inputting the first image feature into the full connection layer to obtain the first output parameter of the DQN training model.

4. The method according to claim 2, wherein the DQN training model comprises a plurality of convolutional neural networks CNN networks, a plurality of recurrent neural networks RNN networks, and a full connection layer, different CNN networks are connected with different RNN networks, a target RNN network of the RNN networks is connected with the full connection layer, the target RNN network includes any one of the RNN networks, the plurality of RNN networks are sequentially connected, and the using the second RGB-D image as the input of the DQN training model to obtain a first output parameter of the DQN training model comprises:
respectively inputting each frame of the second RGB-D image into different CNN networks to extract second image features;
circularly performing a feature extraction step until a feature extraction termination condition is satisfied, the feature extraction step comprises: inputting the second image features into a current RNN network connected with the CNN network, and obtaining a fourth image feature through the current RNN network according to the second image features and a third image feature input by the previous RNN network, and inputting the fourth image feature into the next RNN network; determining the next RNN as an updated current RNN network;
the feature extraction termination condition comprises:
obtaining a fifth image feature output by the target RNN network; and
after the fifth image feature is obtained, inputting the fifth image feature into the full connection layer to obtain the first output parameter of the DQN training model.

5. The method according to claim 2, wherein the performing the migration training on the DQN training model according to the score value and the DQN check model to obtain the target DQN model comprises:
obtaining a third RGB-D image of the current surrounding environment of the target device;
inputting the third RGB-D image into the DQN check model to obtain a second output parameter;
performing calculation according to the score value and the second output parameter to obtain an expected output parameter;
obtaining a training error according to the first output parameter and the expected output parameter; and
obtaining a preset error function, and training the DQN training model according to the training error and the preset error function in accordance with a counterpropagation algorithm to obtain the target DQN model.

6. The method according to claim 1, wherein the inputting the target RGB-D image into the target DQN model to obtain a target output parameter comprises:
inputting the target RGB-D image into the target DQN model to obtain a plurality of to-be-determined output parameters; and
determining a maximum parameter among the plurality of to-be-determined output parameters as the target output parameter.

7. A computer readable storage medium, a computer program is stored thereon, wherein the program, when executed by a processor, implements a method for controlling a device to move, comprising:
collecting a first RGB-D image of a surrounding environment of a target device according to a preset period when the target device moves;
obtaining a second RGB-D image of a preset number of frames from the first RGB-D image;
obtaining a pre-trained deep Q network model DQN training model, and performing migration training on the DQN training model according to the second RGB-D image to obtain a target DQN model;
obtaining a target RGB-D image of the current surrounding environment of the target device;
inputting the target RGB-D image into the target DQN model to obtain a target output parameter, and determining a target control strategy according to the target output parameter; and
controlling the target device to move according to the target control strategy.

8. An electronic device, comprising:
a memory, wherein a computer program is stored thereon; and
a processor, configured to execute the computer program in the memory to implement a method for controlling a device to move, comprising:
collecting a first RGB-D image of a surrounding environment of a target device according to a preset period when the target device moves;
obtaining a second RGB-D image of a preset number of frames from the first RGB-D image;
obtaining a pre-trained deep Q network model DQN training model, and performing migration training on the DQN training model according to the second RGB-D image to obtain a target DQN model;
obtaining a target RGB-D image of the current surrounding environment of the target device;
inputting the target RGB-D image into the target DQN model to obtain a target output parameter, and determining a target control strategy according to the target output parameter; and
controlling the target device to move according to the target control strategy.
